(19) United States
(12) Patent Application Publication
(10) Pub. No.: US 2007/0255793 A1
(43) Pub. Date: Nov. 1, 2007

(54) Method for providing service between heterogeneous networks

(75) Inventors: Jae-Woo Kwon, Suwon-si (KR); Hye-Won Baek, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/789,977

(22) Filed: Apr. 26, 2007

(30) Foreign Application Priority Data
Apr. 26, 2006 (KR) 2006-37690
Jul. 7, 2006 (KR) 2006-63871

(51) Int. Cl. G06F 15/16

(52) U.S. Cl. 709/206

(57) ABSTRACT

A method for a Portable Subscriber Station (PSS) to be provided with a service in a communication system where heterogeneous networks interwork with each other. The method includes receiving a first message including an authorization token that is bearer resource authorization information, generating a flow identifier for distinguishing between at least one service flows by referring to Session Description Protocol information of the PSS, and transmitting a second message including the authorization token and the flow ID.

### PRIORITY

This application claims priority under 35 U.S.C. § 119(a) to a Korean Patent Application filed in the Korean Intellectual Property Office on Apr. 26, 2006 and assigned Serial No. 2006-37690 and a Korean Patent Application filed in the Korean Intellectual Property Office on Jul. 7, 2006 and assigned Serial No. 2006-63871, the disclosures of each of which are incorporated herein by reference.

### BACKGROUND OF THE INVENTION

1. Field of the Invention

The present invention generally relates to a method for providing a service between heterogeneous networks, and in particular, to a method for providing a service in interworking between an Internet Protocol (IP) Multimedia Subsystem (IMS) network and another type of network.

2. Description of the Related Art

An IMS network is intended to provide an IP-based packet communication system. The IMS network is based on a Session Initiation Protocol (SIP) that is a text-based application layer control protocol. The SIP is based on a client/server structure in which a server responds as clients start calling. The SIP has a function in which one or more participants can make, modify, and terminate a session.

Thus, the IMS network is expected to serve as an infra network for providing a Voice over IP (VoIP) service and a multimedia service in an integrated wired/wireless network. However, a scheme for providing various services in interworking between the IMS network and another type of network has not yet been defined.

### SUMMARY OF THE INVENTION

An aspect of the present invention is to address at least the above problems and/or disadvantages and to provide at least the advantages described below. Accordingly, an aspect of the present invention is to provide a method for providing a service in interworking between an IMS network and another type of network.

According to one aspect of the present invention, there is provided a method for a Portable Subscriber Station (PSS) to be provided with a service in a communication system where heterogeneous networks interwork with each other. The method includes receiving a first message including an authorization token that is bearer resource authorization information, generating a flow identifier (ID) for distinguishing between at least one service flows by referring to Session Description Protocol (SDP) information of the PSS, and transmitting a second message including the authorization token and the flow ID.

According to another aspect of the present invention, there is provided a method for a Base Station (BS) to provide a service in a communication system where heterogeneous networks interwork with each other. The method includes receiving a first message including a flow ID for distinguishing at least one service flows and an authorization token that is bearer resource authorization information from a PSS, transmitting a second message including binding information, i.e., combined information of the flow ID and the authorization token, generating a Service Flow ID (SFID) that logically corresponds to the flow ID, and mapping the generated SFID and the flow ID to each other.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 illustrates a system where an IMS network and a portable Internet network interwork with each other according to the present invention;

FIG. 2 illustrates mapping for providing a Quality of Service (QoS) in a system where an IMS network and a portable Internet network interwork with each other according to the present invention;

FIG. 3 is a signal flow diagram illustrating a call connection procedure according to a first embodiment of the present invention;

FIG. 4 is a signal flow diagram illustrating a call connection procedure according to a second embodiment of the present invention;

FIG. 5 is a flowchart illustrating a process in which a Portable Subscriber Station (PSS) is provided with a service according to the present invention;

FIG. 6 is a flowchart illustrating a process in which a BS is provided with a service according to the present invention; and

FIG. 7 illustrates a process in which a BS maps a flow ID and an SFID to each other according to the present invention.

Throughout the drawings, the same drawing reference numerals will be understood to refer to the same elements, features and structures.

### DETAILED DESCRIPTION OF THE PREFERRED EMBODIMENTS

The matters defined in the description, such as construction, elements, etc., are provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a method for providing a service between heterogeneous networks. The heterogeneous networks may be an Internet Protocol (IP) Multimedia Subsystem (IMS) network and a portable Internet network. Although a method for providing a service in interworking between the IMS network and the portable Internet network will be described, the present invention can also be applied to provide a service between the IMS network and any type of network capable of interworking with the IMS network.

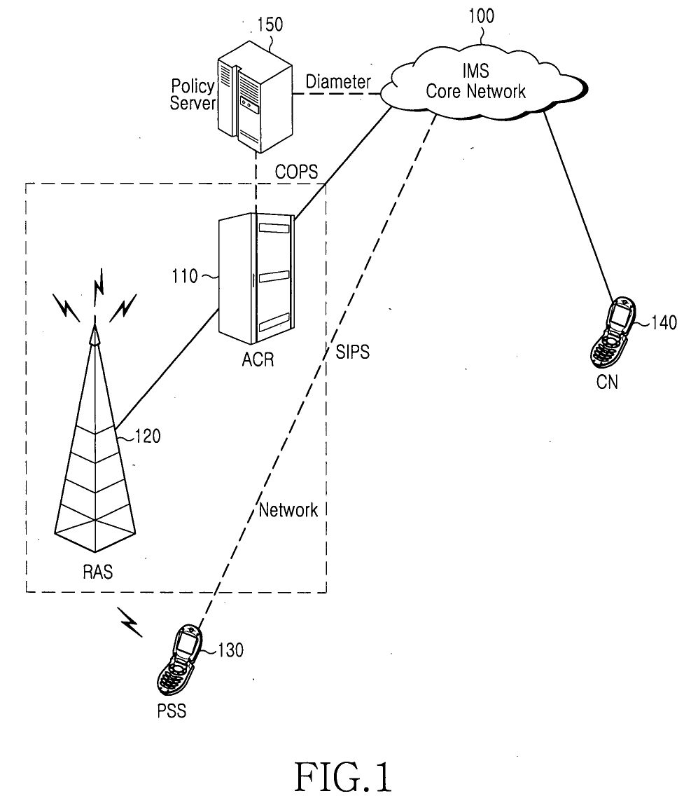

FIG. 1 shows a system in which an IMS network and a portable Internet network interwork with each other according to the present invention. The system includes an IMS core network 100, an Access Control Router (ACR) 110, a Radio Access Station (RAS) 120, a Portable Subscriber Station (PSS) 130, a Correspondent Node (CN) 140, and a policy server 150. The system may further include an Authentication, Authorization, and Accounting (AAA) server (not shown).

The IMS core network 100 may include an IMS server, a Home Subscriber Server (HSS), and a multimedia content providing server, and has a Session Initiation Protocol (SIP) interface with the PSS 130.

The ACR 110 manages connection and mobility of a user and provides interfaces with the RAS 120 and the IMS core network 100. The ACR 110 also exchanges functions related to an IP Convergence Sublayer (CS) with the RAS 120. The interface with the IMS core network 100 may be a Common Open Policy Server (COPS) interface. The ACR 110 may use a diameter interface with the AAA server (not shown). The ACR 110 allocates a unique service flow to each service connection.

The RAS 120 is positioned between the ACR 110 and the PSS 130 in order to provide a communication service to the PSS 130 or perform scheduling based on Medium Access Control (MAC) Quality of Service (QoS) information.

The PSS 130 can be provided with various services such as a VoIP service and supports the Institute of Electrical and Electronics Engineers (IEEE) 802.16 standard.

Once the PSS 130 sets up a call through SIP signaling, the policy server 150 is notified of call generation from the IMS server. The policy server 150 then generates an identifier for each flow of a session, i.e., a flow identifier (ID), and QoS profile information. The generated information is transmitted to the ACR 110 and the ACR 110 applies a QoS for each service flow based on the received information.

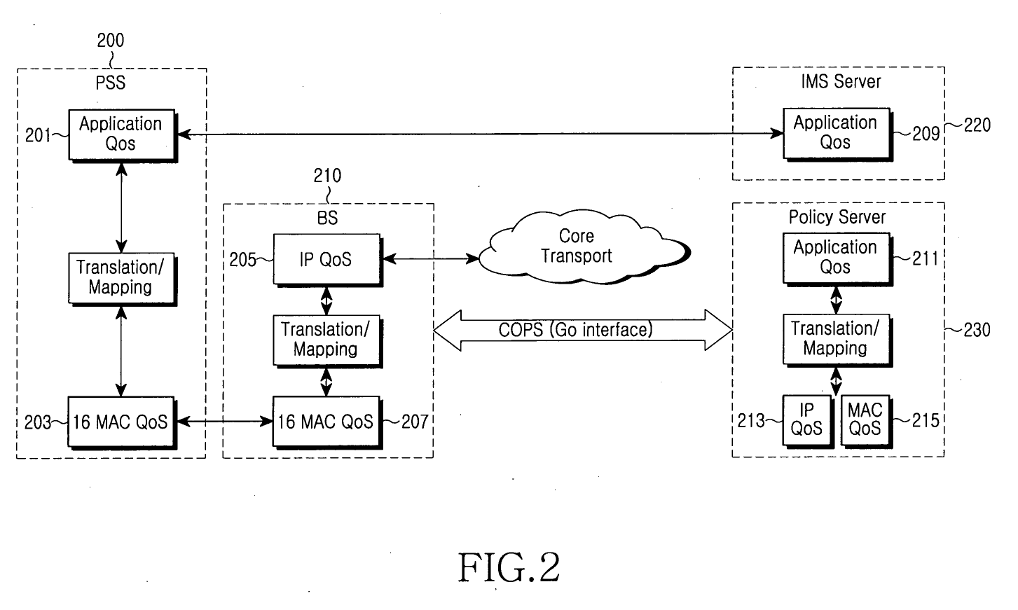

FIG. 2 illustrates mapping for providing a QoS in a system where an IMS network and a portable Internet network interwork with each other according to the present invention. The system may include a portable Internet network including a PSS 200 and a Base Station (BS) 210 and an IMS network including an IMS server 220 and a policy server 230. The BS 210 includes an RAS and an ACR.

The PSS 200, the BS 210, the IMS server 220, and the policy server 230 include units that operate in terms of hardware and/or software in order to provide a QoS and the units maintain and manage profile information for application QoS 201, 209, and 211, 16 MAC QoS 203, 207, and 215 and IP QoS 205 and 213.

Profile information for each QoS can be configured as follows.
Application QoS

Connection information

Media format information

Bandwidth information
IP QoS

Packet classification (5 tuples): Source IP address, Destination IP address, Protocol, Source port number, and Destination port number.

QoS service class: DSCP (Diffserv Code Point)

QoS data rate
16 MAC QoS

Service flow scheduling type

Tolerated jitter

Maximum latency

Maximum sustained traffic rate

Maximum traffic burst

Maximum reserved traffic rate

Maximum tolerable traffic rate

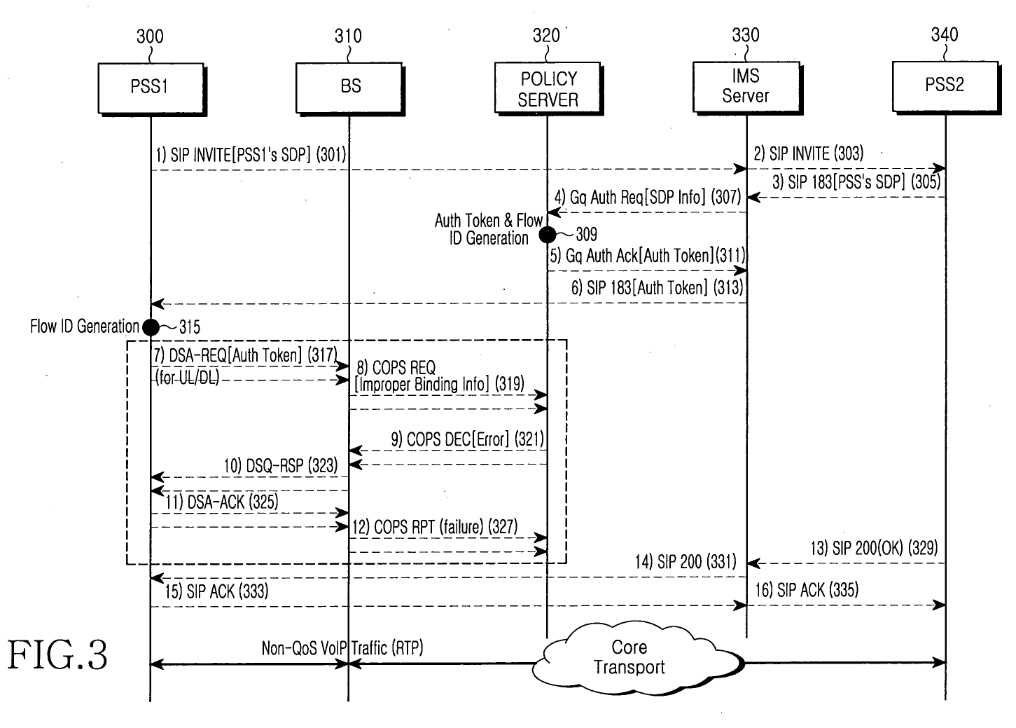

FIG. 3 shows an example of a call connection procedure according to the present invention. A PSS1 300 as a source terminal transmits a Session Initiation Protocol INVITE (SIP_INVITE) message to an IMS server 330 in order to set up connection of a call, e.g., a VoIP call, destined to a destination terminal, i.e., a PSS2 340 in step 301. The SIP_INVITE message includes Session Description Protocol (SDP) information of the PSS1 300. The SDP information includes QoS information and bearer related information of the PSS1 300.

The IMS server 330 transmits the SIP_INVITE message to the PSS2 340 in step 303. The PSS2 340 transmits an SIP 183 message to the IMS server 330 in step 305. The SIP 183 message includes SDP information of the PSS2 340.

The IMS server 330 transmits an authorization request message including SDP information including bearer information for a session to a policy server 320 in step 307. The policy server 320 generates an authorization identifier, i.e., an authorization token, and a flow ID and transmits an ACKnowledge (ACK) message including the generated authorization token and flow ID to the IMS server 330 in step 311. The authorization token includes information about a policy server that manages a QoS profile of a session and QoS authorization information.

The IMS server 330 transmits an SIP 183 message including the authorization token to the PSS1 300 in step 313. The PSS1 300 generates a flow ID in step 315 and encapsulates the QoS information of the PSS1 300 and the authorization token received from the IMS server 330 into a Dynamic Service Addition-REQuest (DSA-REQ) message and transmits the DSA-REQ message to a BS 310 in step 317. The DSA-REQ message is a message requesting connection setup for a session.

The BS 310 transmits a Common Open Policy Server-DECision (COPS-DEC) message including binding information to the policy server 320 in step 319. The binding information means combined information of the authorization token and the flow ID.

The policy server 320 transmits the COPS-DEC message to the BS 310. The COPS-DEC message may include information indicating whether or not service connection is successful. Subsequent processes are not associated with the subject matter of the present invention and thus will not be described.

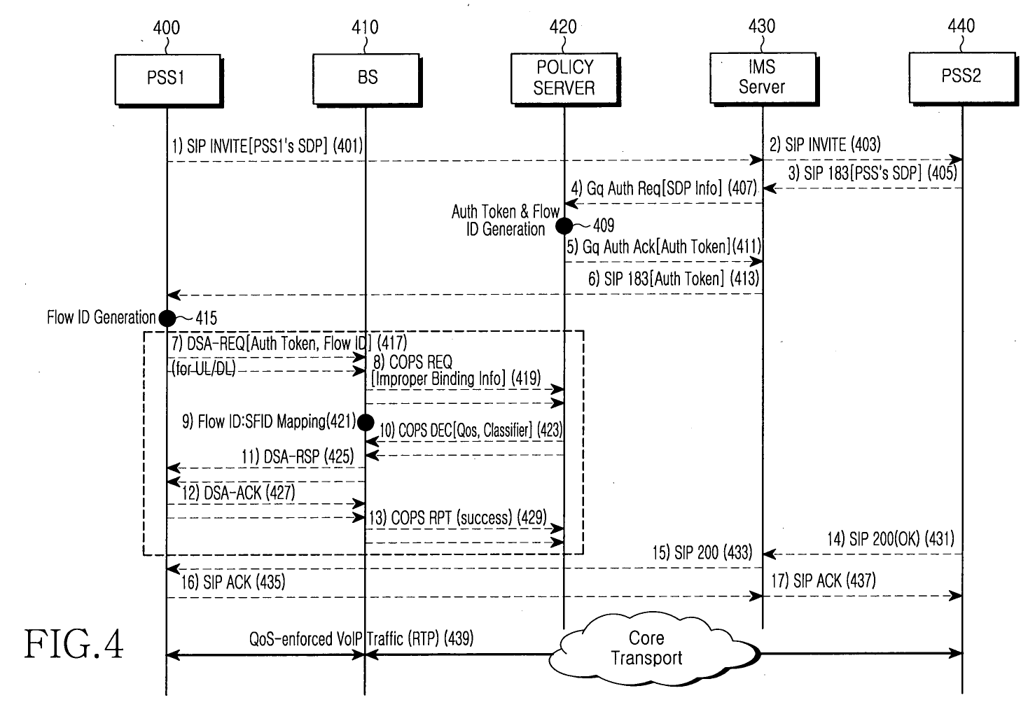

FIG. 4 shows another example of a call connection procedure according to the present invention. A PSS1 400 as a source terminal transmits an SIP_INVITE message to an IMS server 430 in order to set up connection of a call, e.g., a VoIP call, destined to a destination terminal, i.e., a PSS2 440 in step 401. The SIP_INVITE message includes SDP information of the PSS1 400. The SDP information includes QoS information and bearer related information of the PSS1 400.

The IMS server 430 transmits the SIP_INVITE message to the PSS2 440 in step 403. The PSS2 440 transmits an SIP 183 message to the IMS server 430 in step 405. The SIP 183 message includes SDP information of the PSS2 440.

The IMS server 430 transmits an authorization request message including SDP information including bearer information for a session to a policy server 420 in step 407. The policy server 420 generates an authorization identifier, i.e., an authorization token, and a flow ID and transmits an ACKnowledge (ACK) message including the generated authorization token and flow ID to the IMS server 430 in step 411.

The IMS server 430 transmits the SIP 183 message including the authorization token to the PSS1 400 in step 413. The PSS1 400 generates a flow ID for identifying a flow for each medium using its own SDP information in step 415 and transmits a DSA-REQ message including the authorization token received from the IMS server 430 and the generated flow ID in step 417.

The BS 410 transmits a COPS-REQ message including binding information, i.e., combined information of the authorization token and the flow ID, to the policy server 420 in step 419. The BS 410 then maps the flow ID and a Service Flow IDentifier (SFID) to each other in step 412. The SFID is generated by the BS 410 and the BS 410 logically maps the flow ID and the SFID to each other. The flow ID is used to identify a flow for each medium based on SDP information and the SFID means an identifier for unidirectional connection having a particular QoS.

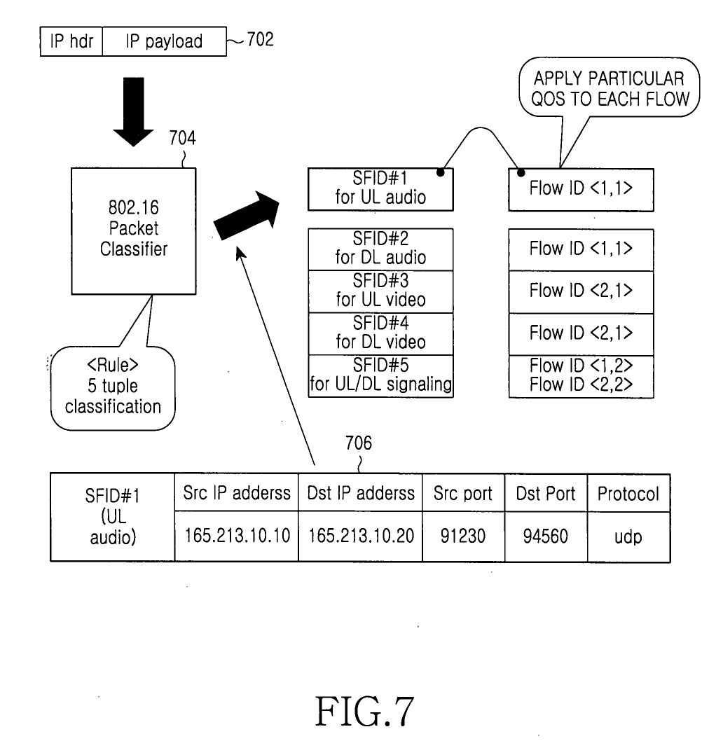

The flow ID is flow information of an application layer, whereas the SFID is flow information of an MAC layer. The flow ID included in the DSA-REQ message received from a PSS is identical in a downlink and an uplink, whereas the SFID has to have a value for distinguishing between a downlink and an uplink. For this reason, the flow ID that is identical in the uplink and the downlink has to be mapped to the SFID that is different in the uplink and the downlink in step 421. Step 421 will be described in more detail with reference to FIG. 7.

The mapped information will serve as binding information for mapping the SFID using QoS profile information provided from the policy server 420 using the flow ID.

The policy server 420 transmits a COPS-DEC message including QoS information and classifier information to the BS 410 in step 423. The policy server 420 maps SDP information for a session to IP QoS information and encapsulates the mapped information into the COPS-DEC message.

The BS 410 having received the COPS-DEC message allocates a bearer resource to a session, maps the received IP QoS information to MAC QoS information, and compares the received IP QoS information with MAC QoS information requested by the PSS1 400 in order to determine a MAC QoS suitable for the PSS1 400. The BS 410 encapsulates the determined MAC QoS information into a Dynamic Service Addition-Response (DSA-RSP) message and transmits the DSA-RSP message to the PSS1 400 in step 427.

The PSS1 400 transmits a DSA-ACK message to the BS 410 in response to the DSA-RSP message in step 427. The BS 410 transmits a COPSRPT message including information indicating that bearer resource allocation and MAC QoS determination are successful to the policy server 420 in step 429.

In step 439, the PSS1 400 can perform traffic exchange to which a QoS provided from the IMS network is applied with the PSS2 440 through SIP message transmission/reception (steps 423 through 437) between the PSS1 400, the IMS server 430, and the PSS2 440.

A PSS generates a flow ID for each medium using SDP information. Table 1 illustrates an example in which a PSS allocates a flow ID for each medium (m) and each uplink (UL)/downlink (DL). In Table 1, “RTP” indicates a Real Time Protocol and “RTCP” indicates a Real Time Control Protocol.

TABLE 1

| Order of ‘m’ | Type of IP | Dest IP | | |
|---|---|---|---|---|
| line | Flow | Address | Port Number | Flow ID |
| 1 | RTP(video) | 165.213.10.10 | 91230 | <1, 1> |
| | UL | | | |
| 1 | RTP(video) | 165.213.10.20 | 94560 | <1, 1> |
| | DL | | | |
| 1 | RTCP UL | 165.213.10.10 | 91231 | <1, 2> |
| 1 | RTCP DL | 165.213.10.20 | 94561 | <1, 2> |
| 2 | RTP(audio) | 165.213.10.10 | 1230 | <2, 1> |
| | UL | | | |
| 2 | RTP(audio) | 165.213.10.20 | 4560 | <2, 1> |
| | DL | | | |
| 2 | RTCP UL | 165.213.10.10 | 1231 | <2, 2> |
| 2 | RTCP DL | 165.213.10.20 | 4561 | <2, 2> |

As mentioned above, the PSS has to encapsulate the flow ID into a DSA-REQ message and transmit the DSA-REQ message to a BS. The BS can apply a QoS profile for each flow using the received flow ID. Table 2 illustrates a DSA-REQ message format that is newly suggested in the present invention.

TABLE 2

| Type | Length | Value | Scope |
|---|---|---|---|
| [145/146].xx | Variable | Flow ID that is | DSA-REQ |
| | | used for enforcing | DSA-RSP |
| | | the QoS for one or | |
| | | service flows | |
| | | generated by MS- | |
| | | initiated higher- | |
| | | level service flow | |
| | | creation or | |
| | | modification | |
| | | procedures | |

Although the flow ID generated by the PSS is transmitted through the DSA-REQ message herein, the flow ID can also be generated by a policy server. Thus, the PSS may receive the flow ID generated by the policy server and encapsulate the received flow ID into the DSA-REQ message for transmission to the BS. When the BS transmits the DSA-RSP message without receiving the DSA-REQ message from the PSS, it may encapsulate the flow ID into the DSA-RSP message for transmission.

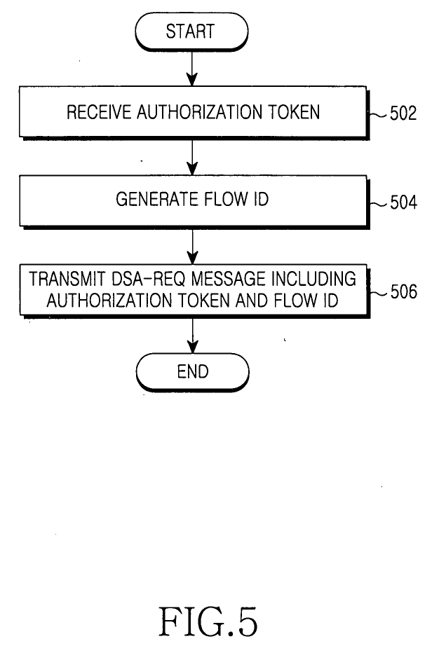

FIG. 5 shows a process in which a PSS is provided with a service according to the present invention. The PSS receives an SIP 183 message including authorization token information from an IMS server in step 502. In step 504, the PSS generates a flow ID. In step 506, the PSS encapsulates the authorization token and the flow ID into a DSA-REQ message and transmits the DSA-REQ message to a BS, thereby requesting the BS to provide a service.

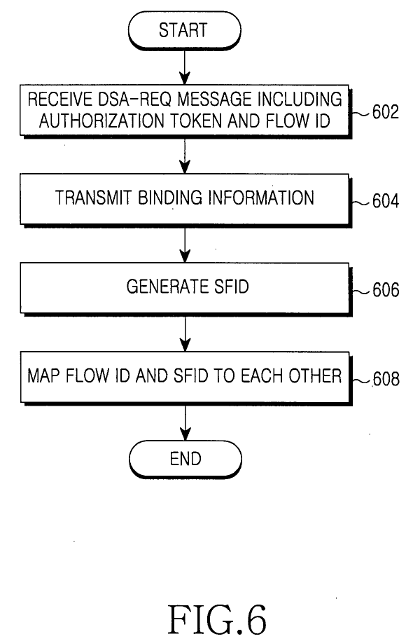

FIG. 6 shows a process in which a BS is provided with a service according to the present invention. The BS receives a DSA-REQ message including an authorization token and a flow ID from a PSS in step 602. In step 604, the BS transmits a COPS-REQ message including binding information, i.e., combined information of the authorization token and the flow ID, to a policy server in step 604. The BS generates an SFID in step 606. The BS maps the flow ID and the SFID to each other in step 608.

FIG. 7 shows a process in which a BS maps a flow ID and an SFID to each other according to the present invention. A packet classifier 704 of the BS detects an Internet Protocol (IP) header from a signal 702 received from a PSS and reads 5-tuple information 706 from the detected header information. The 5-tuple information 706 is an SFID #1 for UL audio. The 5-tuple information 706 includes a source IP address, a destination IP address, a source port number, a destination port number, and a protocol type.

The BS may acquire QoS information for each uplink and/or downlink traffic using the read 5-tuple information 706 and other information. The BS maps a flow ID and a newly generated SFID to each other based on the acquired QoS information. For example, the SFID #1 for UL audio may be mapped to a flow ID<1,1> transmitted from the PSS.

As described above, according to the present invention, when an IMS network and another type of network interwork with each other, a PSS can be provided with an optimized QoS. In particular, in a system where a portable Internet network and the IMS network interwork with each other, the PSS can be provided with an optimized QoS.

While the invention has been shown and described with reference to preferred embodiments thereof, it will be understood by those skilled in the art that various changes in form and details may be made therein without departing from the spirit and scope of the invention.

What is claimed is:

1. A method for a Portable Subscriber Station (PSS) to be provided with a service in a communication system where heterogeneous networks interwork with each other, the method comprising:
receiving a first message including an authorization token that is bearer resource authorization information;
generating a flow identifier (ID) for distinguishing between at least one service flows by referring to Session Description Protocol (SDP) information of the PSS; and
transmitting a second message including the authorization token and the flow ID.

2. The method of claim 1, wherein the first message is a Session Initiation Protocol (SIP) 183 message.

3. The method of claim 1, wherein the second message is a Dynamic Service Addition REQuest (DSA-REQ) message.

4. The method of claim 1, further comprising receiving a third message including associated Quality of Service (QoS) information in response to the second message.

5. The method of claim 4, wherein the third message is a Dynamic Service Addition response (DSA-RSP) message.

6. The method of claim 1, wherein the heterogeneous networks are an Internet Protocol (IP) Multimedia Subsystem (IMS) network and a portable Internet network.

7. A method for a Base Station (BS) to provide a service in a communication system where heterogeneous networks interwork with each other, the method comprising:
receiving a first message including a flow identifier (ID) for distinguishing at least one service flows and an authorization token that is bearer resource authorization information from a Portable Subscriber Station (PSS);
transmitting a second message including binding information that is combined information of the flow ID and the authorization token;
generating a Service Flow ID (SFID) that logically corresponds to the flow ID; and
mapping the generated SFID and the flow ID to each other.

8. The method of claim 7, wherein the first message is a Dynamic Service Addition REQuest (DSA-REQ) message.

9. The method of claim 7, wherein the second message is a Common Open Policy Service-REQuest (COPS-REQ) message.

10. The method of claim 7, wherein the mapping between the SFID and the flow ID is used in order to identify a Quality of Service (QoS) profile provided from a policy server.
